(19) United States
(12) Patent Application Publication
(10) Pub. No.: US 2013/0131890 A1
(43) Pub. Date: May 23, 2013

(54) METHODS AND SYSTEMS OF ENHANCING ACCELERATION INFORMATION

(71) Applicant: Cartasite Inc., Denver, CO (US)

(72) Inventor: David Lansdell Armitage, Golden, CO (US)

(73) Assignee: CARTASITE INC., Denver, CO (US)

(21) Appl. No.: 13/678,142

(22) Filed: Nov. 15, 2012

Related U.S. Application Data
(60) Provisional application No. 61/561,017, filed on Nov. 17, 2011.

(51) Int. Cl. G06F 17/00

(52) U.S. Cl. CPC G06F 17/00
USPC 701/1

(57) ABSTRACT

The present invention relates to using information from a monitoring device and other vehicle information from a supplemental device to create enhanced data about an event involving the vehicle. An event could include vehicle turning events, vehicle acceleration, a vehicle braking event, among others. In some examples a scalar acceleration value corresponding to the vehicle is processed with supplemental information to produce enhanced acceleration information.

### CROSS REFERENCE TO RELATED APPLICATIONS

This application claims priority to, and benefit from, provisional patent Application No. 61/561,017 filed Nov. 17, 2011 entitled “METHODS AND SYSTEMS OF ENHANCING ACCELERATION INFORMATION”, which is incorporated herein by reference for all purposes.

### BACKGROUND

Vehicles use a multitude of different monitoring devices to provide information regarding driving events. Examples of driving events include information relating to vehicle speed, vehicle location, engine emissions, tire pressure, etc. Examples of monitoring devices could include tire pressure gauges, accelerometers, temperature gauges, etc. As information from each monitoring device is collected, further insight into events involving a vehicle can be gained by combining information collected from each monitoring device.

Acceleration monitoring devices, or accelerometers, provide information relating to the acceleration of a vehicle. In order for accelerometers to provide an accurate acceleration value, it is important that the accelerometer's axis be on the same symmetrical plane as the vehicle's axis, and/or the surface on which the vehicle is travelling.

### OVERVIEW

Disclosed are methods and systems of enhancing acceleration and other vehicle information. The method includes receiving a scalar acceleration value generated by an accelerometer device positioned within a vehicle, receiving supplemental information generated by a supplemental device positioned within the vehicle, and generating enhanced acceleration and other information describing the event based at least in part on the scalar acceleration value and the supplemental information.

The system includes an accelerometer device positioned within a vehicle, capable of generating and transmitting a scalar acceleration value; a supplemental device positioned within the vehicle, capable of generating and transmitting supplemental information; and a vehicle analysis system, capable of receiving information and generating enhanced acceleration information describing the event based on the scalar acceleration value and the supplemental information. More accurate acceleration information may be determined using externally provided information, including directional or behavioral information related to the movement of vehicle.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a vehicle analysis system.

FIG. 2 is a flow diagram illustrating a method of enhancing acceleration information.

FIG. 3 is a system diagram illustrating an accelerometer's axis out of alignment with a vehicle's axis.

FIG. 4 is a system diagram illustrating vehicle analysis system receiving information for processing via accelerometer and global positioning system.

FIG. 5 is a system diagram illustrating vehicle analysis system receiving information for processing via accelerometer and on-board diagnostics.

### DETAILED DESCRIPTION

Through the procedures described herein, scalar acceleration information of a moving vehicle is processed to contextualize an event involving the vehicle. In some embodiments, scalar acceleration information of a moving vehicle is coupled with directional or behavioral information to contextualize an event involving the vehicle.

The acceleration information is provided by an acceleration monitoring device which may have an axis lying on a different symmetrical plane than that of vehicle's axis. This acceleration information could comprise scalar (non-vector) acceleration, such as a magnitude of acceleration, which could be calculated using a dot product of the acceleration information for each of the three directional axes (i.e. x, y, and z axes), among other procedures. This acceleration information could also comprise vector acceleration, such as a magnitude and direction of acceleration.

Scalar acceleration information, once determined, can be processed against externally provided information, including directional or behavioral information related to the movement of vehicle, where the acceleration monitoring device itself typically does not supply this external information. The externally monitored information can be processed against the scalar acceleration information to determine vector acceleration information, comprising a direction and a magnitude, or to provide information relating to driving behavior.

Driving behaviors could include information relating to when vehicle turned, if an individual drove in a proper manner relative to the route taken, among many others. Thus, in one embodiment, a complicated calibration or axis-relational procedure to relate the axis of the acceleration monitoring device to the axis of the monitored vehicle can be avoided. Additionally, processing behavioral information against the scalar acceleration information allows for a better understanding of a driving event, such as a braking event, antilock braking system, tire pressure, etc.

As discussed herein, the directional or behavioral information about the monitored vehicle can be provided by a supplemental device. This supplemental device could include a global positioning system (GPS) receiver, vehicle monitoring device, such as an ODB-II compliant monitoring device, or other devices capable of monitoring driving events, including combinations thereof.

The supplemental device may include devices included in the vehicle when manufactured, or aftermarket devices. The supplemental device may communicate via a CAN bus or CAN protocol. CAN (controller area network) bus is a vehicle bus standard designed to allow microcontrollers and devices to communicate with each other within a vehicle without a host computer. CAN bus is a message-based protocol, designed specifically for automotive applications.

The supplemental device could provide a three-axis (or reduced number of axes) measurement for the vehicle. The scalar acceleration value provided by the acceleration monitoring device can then be applied to this three-axis measurement to establish a vector representation of the acceleration of the vehicle. In some examples, the acceleration is only desired for the present direction of travel of vehicle, thus the spatial normalizing information comprises a direction of travel, and is processed against the scalar acceleration value to determine a vector acceleration value. The supplemental device could also provide information relating to the velocity of the vehicle, pedal position data concerning the vehicle, a comparison of the planned route versus the actual route, a statistical analysis concerning an individual's driving behavior, the signature of an individual's driving events, the status of the anti-lock braking system, tire pressure, among other possible driving events that could be monitored.

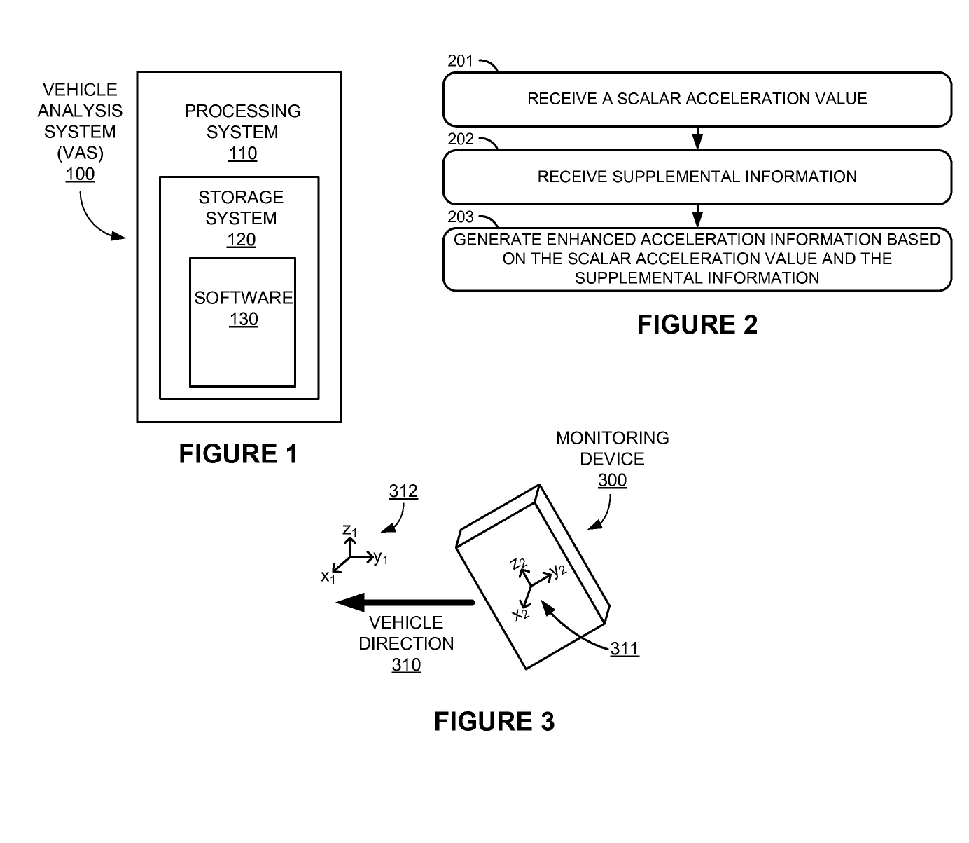

FIG. 1 is a system diagram illustrating vehicle analysis system (VAS) 100, according to an example. VAS 100 includes processing system 110, storage system 120, and software 130. In some examples, VAS 100 is located within either the acceleration monitoring device or the supplemental device. In other examples VAS 100 is located within one device comprising the acceleration monitoring device, the supplemental device, and the VAS 100. In yet another example the VAS 100 is separate from both the acceleration monitoring device and the supplemental device.

Processing system 110 includes storage system 120. Processing system 110 retrieves and executes software 130 from storage system 120. In some examples, processing system 110 comprises specialized circuitry, and software 130 or storage system 120 could be included in the specialized circuitry to operate processing system 110 as described herein. Storage system 120 could include a computer-readable medium such as a disk, tape, integrated circuit, server, or some other memory device, and also may be distributed among multiple memory devices. Software 130 may include an operating system, logs, utilities, drivers, networking software, and other software typically loaded onto a computer system. Software 130 could contain an application program, firmware, or some other form of computer-readable processing instructions. When executed by processing system 110, software 130 directs processing system 110 to operate as described herein, such as receive vehicle acceleration information and directional or behavioral information, and process the information to determine either an acceleration vector or driving behavior.

FIG. 2 is a flow diagram illustrating a method of enhancing acceleration information, according to one example method. In operation 201, a scalar acceleration value is received. In operation 202, supplementation information is received. In operation, enhanced acceleration information is generated 203 based at least in part on the scalar acceleration value received and the supplemental information received, and/or other information. The enhanced information may then be transmitted to another system for use for other purposes.

Information is received (201) from a monitoring device 300 at a VAS 100. Supplemental information is received (202) from a supplemental device (410, 510) at VAS 100. VAS 100 then generates enhanced information 203 based at least in part on the information and supplemental information.

It will be appreciated that the VAS may be on the vehicle and the enhanced information may be transmitted to a server for use for analysis purposes. Furthermore, VAS 100 may be located remote from the vehicle and the information and enhanced information may be transmitted to the remote location for processing.

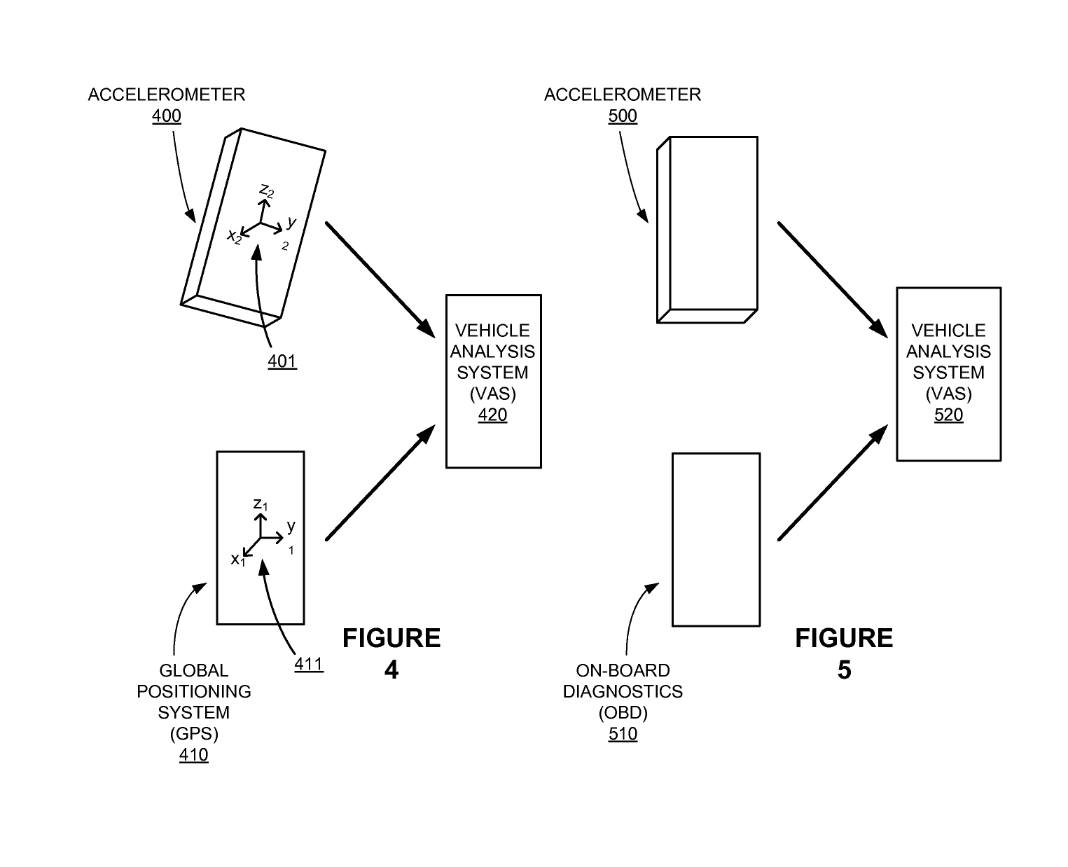

FIG. 3 is a system diagram illustrating monitoring device's 300 axis 311 out of alignment with vehicle's axis 312. In FIG. 3, monitoring device is shown as accelerometer 300. Other monitoring devices could be substituted for accelerometer 300. Accelerometer's axis (x₂, y₂, z₂) 311 may not lie on the same symmetrical plane as vehicle's axis (x₁, y₁, z₁) 312. While accelerometer 300 can accurately monitor scalar acceleration information corresponding to vehicle, the differences between accelerometer's axis 311 and vehicle's axis 312 make it difficult for accelerometer 300 to generate accurate vector acceleration information corresponding to vehicle acceleration and vehicle direction 310.

In this example, information from monitoring device 300 may be used with supplemental information from a supplemental device to generate a more accurate vehicle acceleration value.

FIG. 4 is an example system diagram illustrating vehicle analysis system (VAS) 420 receiving information for processing via accelerometer 400 and a supplemental device/global positioning system (GPS) 410. Accelerometer's axis (x₂, y₂, z₂) 401 may not lie on the same symmetrical plane as GPS's axis (x₁, y₁, z₁) 411.

VAS 420 processes information received from accelerometer 400 and GPS 410 to describe an event involving vehicle. Vehicle may be a passenger car, passenger truck, flatbed truck, semi-trailer and tractor, construction vehicle, railway car, boat, aircraft, or other means of transportation. Vehicle includes accelerometer 400 and GPS 410. Vehicle may include VAS 420 or VAS 420 may be located externally from vehicle. In some examples, VAS 420 is located within either accelerometer 400 or GPS 410. In other examples VAS 420 is located within one complete device comprising accelerometer 400, GPS 410, and VAS 420. In yet another example VAS 420 is separate from both accelerometer 400 and GPS 410.

Accelerometer 400 could be any device capable of monitoring acceleration or other information. Accelerometer 400 includes circuitry to detect and monitor the acceleration of vehicle. This circuitry could include sensors, micro-electromechanical sensors (MEMS), optics, gyroscopes, inertial masses, amplifiers, conditioners, analog-to-digital converters, digital-to-analog converters, logic, or microprocessors, among other circuitry. Additionally, accelerometer 400 could also collect, store, and report other information, such as position, time, battery life, sensor status, inoperative sensors, serial numbers, among other information.

Accelerometer 400 could also include a communication link for communication with VAS 420. In some examples, the communication link includes a wireline transceiver for communicating over a wire, optical fiber, or other medium. In other examples, the communication link includes a wireless transceiver and antenna. In further examples, the communication link is a software or logical link.

Accelerometer 400 could also include a processing portion for receiving sensor information, amplifying, scaling, modifying, adjusting, digitizing, or converting the information, as well as for controlling the transceiver portion and sensor portion. Accelerometer 400 could also comprise a power system, such as a battery or solar cell.

GPS 410 may be any supplemental device capable of spatially normalizing an object's axis. Other supplemental devices can include on-board diagnostic devices (OBD-II), mapping devices, other sensor on the vehicle, and/or some other spatial normalizing device including combinations thereof. Although one GPS 410 is shown in FIG. 4, it should be understood that a different number of supplemental devices could be shown alone or working in unison.

Supplemental device/GPS 410 is a global positioning system in this example. Generally, GPS 410 receives and interprets signals from positioning satellites to determine geographic coordinates. GPS 410 comprises radio frequency (RF) communication circuitry and antenna elements. The RF communication circuitry typically includes amplifiers, filters, modulators, and signal processing circuitry.

In many examples, GPS 410 includes circuitry and equipment to exchange communications of wireless communication services over wireless links. In other examples, GPS 410 includes circuitry and equipment to exchange communications of wired communication services over wireline links such as wire, optical fiber, or other medium. In further examples, the communication link is a software or logical link. GPS 410 may also include user interface systems, memory devices, computer-readable storage mediums, software, processing circuitry, cameras, sensor systems, accelerometers, compasses, or other communication and circuitry components.

In operation, accelerometer 400 senses and monitors acceleration events associated with vehicle's movement. Acceleration events sensed and monitored by accelerometer 400 could include braking, directional change, steering, change in elevation, acceleration, velocity, position, or time among other information. Accelerometer 400 may also be configured to collect, store, convert, and transfer the monitored acceleration information concerning vehicle.

In some examples, accelerometer 400 is placed in vehicle such that its axis 401 will not lie on the same symmetrical plane as GPS's axis 411. This arrangement makes it difficult for accelerometer 400 to accurately convey vector acceleration information based upon its axis 401. In order to convey accurate vector acceleration information accelerometer 400 could convert its axis 401 to GPS's axis 411. However, this method involves unnecessary calculation and energy expenditure.

To avoid the above mentioned method, the following example may be used. Accelerometer 400 monitors acceleration information of vehicle. The monitored acceleration information is then sent by accelerometer 400 via a communication link to VAS 420. Scalar acceleration information relating to vehicle could be determined by either VAS 420 or accelerometer 400, however, in this example VAS 420 processes the monitored acceleration information into scalar acceleration information. VAS 420 could then further process the scalar acceleration information along with vector information provided by GPS 410 via communication link to generate a vector format for the scalar acceleration information.

FIG. 5 is an example system diagram illustrating vehicle analysis system (VAS) 520 receiving information for processing via monitoring device/accelerometer 500 and supplemental device/on-board diagnostics (OBD) 510.

VAS 520 processes information received from accelerometer 500 and OBD 510 to describe one or more events involving vehicle. Vehicle could be a passenger car, passenger truck, flatbed truck, semi-trailer and tractor, construction vehicle, railway car, boat, aircraft, or other means of transportation. Vehicle includes accelerometer 500 and OBD 510. Vehicle may include VAS 520 or VAS 520 may be located externally from vehicle. In some examples, VAS 520 is located within either accelerometer 500 or OBD 510. In other examples VAS 520 is located within one complete device comprising accelerometer 500, OBD 510, and VAS 520. In yet another example VAS 520 is separate from both accelerometer 500 and OBD 510.

Accelerometer 500 could be any device capable of monitoring acceleration or other information relating to the vehicle. Accelerometer 500 includes circuitry to detect and monitor the acceleration of vehicle. This circuitry could include sensors, micro-electromechanical sensors (MEMS), optics, gyroscopes, inertial masses, amplifiers, conditioners, analog-to-digital converters, digital-to-analog converters, logic, or microprocessors, among other circuitry. Additionally, accelerometer 500 could also collect, store, and report other information, such as position, time, battery life, sensor status, inoperative sensors, serial numbers, among other information.

Accelerometer 500 could also include a communication link for communication with VAS 520. In some examples, the communication link includes a wireline transceiver for communicating over a wire, optical fiber, or other medium. In other examples, the communication link includes a wireless transceiver and antenna. In further examples, the communication link is a software or logical link.

Accelerometer 500 could also include a processing portion for receiving sensor information, amplifying, scaling, modifying, adjusting, digitizing, or converting the information, as well as for controlling the transceiver portion and sensor portion. Accelerometer 400 could also comprise a power system, such as a battery or solar cell.

Supplemental device/OBD 510 is an on-board diagnostics system in this example. Generally, OBD 510 reports information concerning the activities of various sub-systems of a vehicle for vehicle monitoring purposes. Vehicle activities monitored by OBD 510 could include pedal position, vehicle velocity, vehicle steering, vehicle acceleration, vehicle emissions, battery life, inoperative sensors, tire pressure, statues of the anti-lock braking system, and/or engine efficiency, among other information relating to the vehicle. In some examples, OBD 510 can use a standardized digital communications port to provide real-time data in addition to a standardized series of diagnostic trouble codes which allow a user to rapidly identify and remedy malfunctions within the vehicle.

OBD 510 may include a communication link for communication with VAS 520. In some examples, the communication link includes a wireline transceiver for communicating over a wire, optical fiber, or other medium. In other examples, the communication link includes a wireless transceiver and antenna. In further examples, the communication link is a software or logical link. OBD 510 could be any device capable of monitoring various sub-systems of a vehicle. Although one OBD or reporting device is shown in FIG. 5, it should be understood that a different number of devices could be shown alone or working in unison to provide the data mentioned above.

In operation, accelerometer 500 senses and monitors acceleration events associated with a vehicle's movement. Acceleration events sensed and monitored by accelerometer 500 could include braking, directional change, steering, change in elevation, acceleration, velocity, position, and/or time among other information. Accelerometer 500 may also be configured to collect, store, convert, and transfer the monitored acceleration information concerning vehicle. Accelerometer 500 may be placed in vehicle such that its axis will not lie on the same symmetrical plane as OBD's axis. VAS 520 could process scalar acceleration information against information provided by OBD 510 in order to convey information concerning a driving event.

In one example, the information monitored and provided to VAS 520 via OBD 510 could be vehicle speed, which is the magnitude of vehicle's velocity. VAS 520 could then process scalar acceleration information provided by accelerometer 500 along with vehicle speed information provided by OBD 510 to classify whether a directional change occurred during vehicle's operation. This directional change could be classified as a turn, an incline, or a decline, among other types of information.

In another example, the information monitored and provided to VAS 520 via OBD 510 could be vehicle pedal position data. VAS 520 could then process the scalar acceleration information provided by accelerometer 500 against pedal position data to determine an individual's driving characteristics including how often vehicle's brakes are applied, how often vehicle accelerates, and if an acceleration event is caused by an individual driver or a directional change. This information may be useful to instruct drivers about reducing gas consumption, among other uses.

In yet another example, either VAS 520 or OBD 510 is programmed with the planned route to be taken by vehicle, including the driving characteristics associated with the route, such as number of turns, number of accelerations, number of braking events, umber of time the anti-lock braking system is engaged, and so forth. OBD 510 could then report data concerning the actual route driven by vehicle and individual's actual driving characteristics to VAS 520. VAS 520 could then process planned route against actual route with scalar acceleration information provided by accelerometer 500 to determine driving behavior including how often vehicle's brakes are applied, how often vehicle accelerates, and how often vehicle turned.

In a fourth example, VAS 520 receives scalar acceleration information corresponding to vehicle motion via accelerometer 500. VAS 520 could then use the collected scalar acceleration information to compile a history of vehicle's movement at various moments in time. Using this history, VAS 520 may then be programmed to predict future acceleration events using statistical probability.

In a fifth example, VAS 520 receives scalar acceleration information corresponding to vehicle motion via accelerometer 500. VAS 520 could then compile a history of collected scalar acceleration information to express an individual's driving signature. Using this information, VAS 520 could then be programmed to determine if a particular scalar acceleration was a turn, an acceleration event, or a braking event based on the individual's driving signature.

FIGS. 1-5 and the previous descriptions depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method for enhancing acceleration information, comprising:
receiving, at a vehicle analysis system, a information generated by an monitoring device positioned within a vehicle, wherein the information corresponds generally to an event involving the vehicle;
receiving supplemental information generated by a supplemental device positioned within the vehicle, wherein the supplemental information relates to the event; and
generating enhanced information relating to the event based at least in part on the information and the supplemental information.

2. The method of claim 1, wherein the monitoring device comprises an accelerometer, and the information comprises a scalar acceleration value.

3. The method of claim 2, wherein the supplemental information comprises a directional acceleration value, the supplemental device comprises a device configured to determine geographical coordinates, and the enhanced information comprises a vector acceleration value.

4. The method of claim 2, wherein the supplemental information comprises a vehicle speed value, the supplemental device comprises a device configured to determine vehicle speed, and the enhanced information comprises a directional change of the vehicle.

5. The method of claim 2, wherein the supplemental information comprises information regarding planned driving route and actual driving route, the supplemental device comprises a device configured to determine the planned driving route and the actual driving route, and the enhanced information comprises driving characteristics.

6. The method of claim 2, wherein the supplemental information comprises information regarding vehicle pedal position, the supplemental device comprises a device configured to determine the vehicle pedal position, and the enhanced information comprises driving characteristics.

7. The method of claim 1, wherein the supplemental device comprises original equipment included with the vehicle.

8. The method of claim 1, wherein the supplemental information is received in the format of controller area network protocol.

9. The method of claim 1, wherein the supplemental information comprises anti-lock braking information, and/or tire pressure information.

10. A system for enhancing acceleration information, comprising:
an interface system, configured to receive a scalar acceleration value and supplemental information relating to an event involving a vehicle; and
a processing system, configured to generate enhanced acceleration information describing the event based at least in part on the scalar acceleration value and/or the supplemental information;
wherein the supplemental information comprises a directional acceleration value, and the enhanced acceleration information comprises a vector acceleration value.

11. The system of claim 10, wherein the supplemental information comprises a vehicle speed value, and the enhanced acceleration information comprises a directional change of the vehicle.

12. The system of claim 10, wherein the supplemental information comprises information regarding planned driving route and actual driving route, and the enhanced acceleration information comprises driving characteristics.

13. The system of claim 10, wherein the supplemental information comprises information regarding vehicle pedal position, and the enhanced acceleration information comprises driving characteristics.

14. The system of claim 10, wherein the supplemental information is received in the format of controller area network protocol, and the supplemental device is configured to communicate with the controller area network of the vehicle.

15. The system of claim 10, wherein the supplemental information comprises anti-lock braking information, and/or tire pressure information.

16. A non-transitory computer readable medium having stored thereon program instructions that, when executed by a vehicle analysis system, direct the vehicle analysis system to generate a vector acceleration value, the program instructions comprising:
identifying a scalar acceleration value generated by an accelerometer device positioned within a vehicle, wherein the scalar acceleration value relates to an event involving the vehicle;
identifying a directional acceleration value generated by a device configured to determine geographical coordinates positioned within the vehicle, wherein the directional acceleration value relates to the event; and
generating the vector acceleration value relating to the event based at least in part on the scalar acceleration value and/or the directional acceleration value.

17. The non-transitory computer readable medium of claim 16, further comprising receiving supplemental information from a supplemental device, wherein the supplemental information is received in the format of controller area network protocol.

18. The non-transitory computer readable medium of claim 17, wherein the supplemental information comprises anti-lock braking information, geographical coordinates, directional change of the vehicle, planned driving route, vehicle pedal position, and/or tire pressure information, and/or combinations thereof.

19. The non-transitory computer readable medium of claim 17, wherein the supplemental device is coupled to a controller area network of the vehicle.

20. The non-transitory computer readable medium of claim 17, wherein the supplemental information comprises a vehicle speed value, and an enhanced acceleration information is determined based at least in part on the supplemental information, wherein the enhanced information comprises a directional change of the vehicle.
